(19) United States
(12) Patent Application Publication
(10) Pub. No.: US 2025/0173237 A1
(43) Pub. Date: May 29, 2025

(54) REPLAY OF USER INTERACTIONS WITH ONLINE APPLICATIONS

(71) Applicant: Sprig Technologies Inc., San Francisco, CA (US)

(72) Inventors: Andrew Daesun Park, San Francisco, CA (US); Qiang Zheng, Mountain View, CA (US); Christopher Matthew Lee, Queens, NY (US); Elliot Adrian Conte, Upperco, MD (US); Ryan James Glasgow, Orinda, CA (US)

(21) Appl. No.: 18/952,031

(22) Filed: Nov. 19, 2024

Related U.S. Application Data
(60) Provisional application No. 63/604,122, filed on Nov. 29, 2023.

(51) Int. Cl. G06F 11/34; G06F 3/0484

(52) U.S. Cl. CPC G06F 11/3438; G06F 3/0484

(57) ABSTRACT

A system generates session replays that capture event data representing user actions performed with an online application. A session replay is configured to be associated with events of a trigger event type. A display of a user interface of the online application is displayed via a client device. The system stores event data describing user actions performed via the user interface of the online application in a replay data store. The replay data store retains event data representing user actions performed within a recent time interval. The system detects an occurrence of a trigger event of the trigger event type and extracts session replay data representing user actions performed with the online application via the client device within a threshold time prior to the trigger event. The session replay data is sent for display via a dashboard user interface.

### CROSS REFERENCE TO RELATED APPLICATIONS

This application claims the benefit of U.S. Provisional Application No. 63/604,122, filed Nov. 29, 2023, which is incorporated by reference in its entirety.

### BACKGROUND

This disclosure generally relates to user interactions with systems and, in particular, to replay of user interactions with systems.

Users perform interactions with systems, for example, online systems or online applications to utilize the features offered by the systems. Online applications are designed to let users perform specific workflows. Some of the features of an online features may be designed to encourage users to perform certain actions. For example, certain widgets may be presented via the user interface to cause users to perform certain actions. However, in production, the users may not use the online application in expected ways. For example, users may get confused with certain portions of the user interface and perform unexpected user actions. As a result, features of the online application may not be utilized as expected. For example, users may be dissatisfied with the usability of certain features even though they may not have been using the application as expected. Typical user interactions with an online application may be studied during testing and development of the online application. However, the behavior of users in production may not match the behavior of the users performing testing of the application. The behavior of users in a production environment is challenging to capture.

### SUMMARY

A system generates session replays that capture event data representing user actions performed with an online application. The system receives an indication that session replays are enabled for an online application. A session replay is configured to be associated with events of a trigger event type. A display of a user interface of the online application is displayed via a client device. The system repeatedly stores event data describing user actions performed via the user interface of the online application in a replay data store. The replay data store retains event data representing user actions performed within a recent time interval. The system detects an occurrence of a trigger event of the trigger event type. Responsive to detecting the occurrence of the trigger event of the trigger event type, the system extracts session replay data representing user actions performed with the online application via the client device within a threshold time prior to the trigger event. The session replay data is sent for display via a dashboard user interface.

According to an embodiment, the trigger event is associated with an online survey associated with the online application. For example, the trigger event may trigger the online survey and the session replay data comprises user actions associated with the online survey including user actions performed within the threshold time before the trigger event.

According to an embodiment, the system deletes event data representing user actions that are older than the threshold time compared to a current time.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1A is a block diagram of a system environment in which a real-time survey system operates, in accordance with an example embodiment.

FIG. 1B is a screenshot of a dashboard 125 that allows a user to view session replays captured by the system according to an embodiment.

FIG. 2 is a block diagram showing the architecture of a real-time survey system, in accordance with an example embodiment.

FIG. 3 is a block diagram of an administration module of a real-time survey system, in accordance with an example embodiment.

FIG. 4 is a block diagram of a response processing module of a real-time survey system, in accordance with an example embodiment.

FIG. 5 shows an example user interface for displaying real-time survey content to a user of the application, in accordance with an example embodiment.

FIG. 6 is a flowchart illustrating an example process for selecting, displaying, and analyzing a real-time survey displayed to a user via a user device, according to an embodiment.

The figures depict various embodiments for purposes of illustration only. The figures use like reference numerals to identify like elements. One skilled in the art will readily recognize from the following discussion that alternative embodiments of the structures and methods illustrated herein may be employed without departing from the principles described herein.

### DETAILED DESCRIPTION

### System Architecture

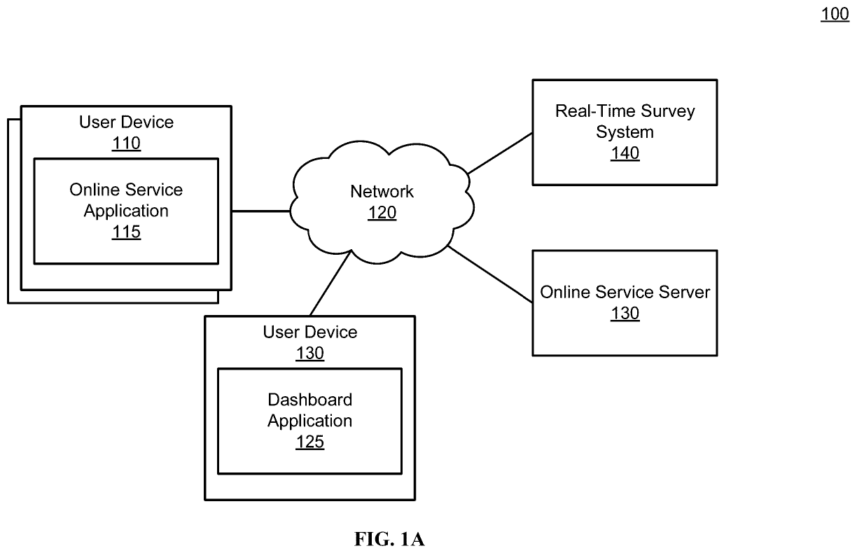

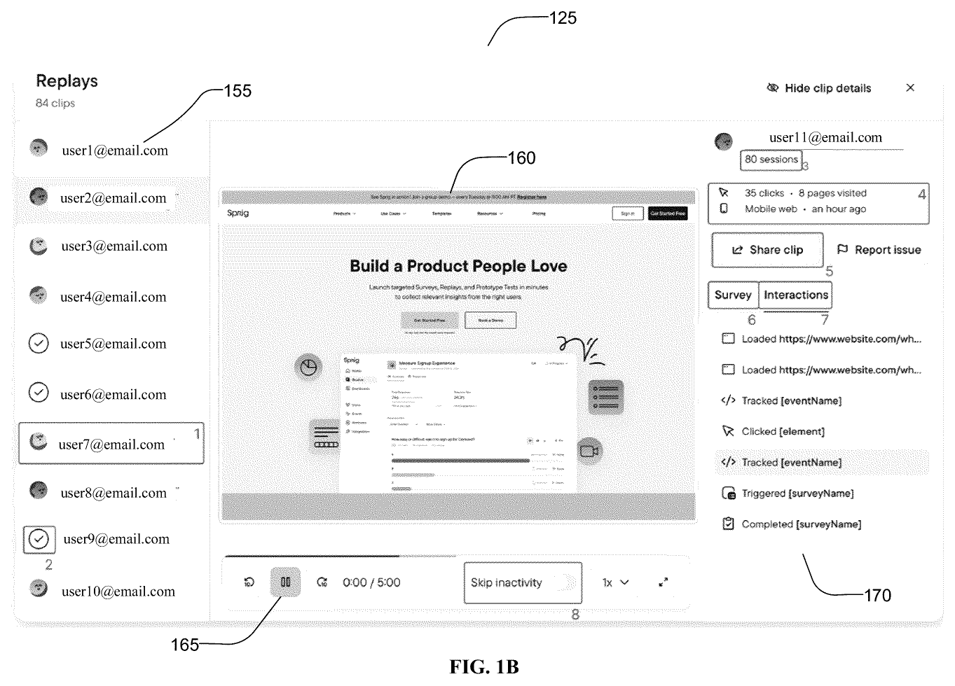

FIG. 1A is a block diagram of a system environment in which a real-time survey system operates, in accordance with an example embodiment. The environment 100 of FIG. 1 includes a set of user devices 110 running an online service application 115, a network 120, an online service server 130 associated with the application 115, and a real-time survey system 140. In other embodiments, the environment 100 may include additional, fewer, or different entities. For example, only one online service application 115 and online service server 130 is shown in environment 100, but other implementations can include multiple applications 115, each associated with one more online service servers 130. Similarly, the online service server 130 and the real-time survey system 140 are shown as separate entities, but in some embodiments, the real-time survey system may be integrated within the online service server 130. The online service application may also be referred to herein as an online application.

Each user device 110 includes one or more computing devices capable of displaying content to users, receiving user input, and transmitting and/or receiving data via the network 120. A user device 110 can include conventional computing systems, such as desktop or laptop computer, personal digital assistants (PDA), mobile phones, smartphones, smartwatches, wearable devices, or other suitable devices. Each user device 110 can be configured to communicate with the online service server 130 or real-time survey system 140 via the network 120. In some implementations, user devices 110 execute an online service application 115 associated with an online service server 130. A user device may also be referred to herein as a client device or a device.

The online service application 115 can allow a user of the user device 110 to interact with the online service server 130 and/or real-time survey system to view content, provide user input, and/or view and respond to real-time surveys based on their activities within the online service application 115. For example, the online service application 115 can be a browser application enabling interaction between the user device 110 and the online service server 130 via the network 120. In other cases, user devices 110 interact with the online service server 130 through an application programming interface (API) running on a native operating system of the user device 110. In some implementations, the online service application 115 is affiliated with the online service server 130, for example, the online service application 115 and online service server 130 can be created and managed by the same entity.

An online service application 115 can record and store event data about the user's actions as the user interacts with the online service application 115. In some implementations, this data is later sent to the real-time survey system 140 for aggregation and analysis of survey results. In some embodiments, the online service application 115 displays real-time survey content to users via a user interface (UI) or UI element appearing in addition to the standard application UI for interacting with the online service server 130.

In some embodiments the online service application 115 can be configured to enable a session replay. A session replay allows a user, for example, a system administrator to replay user interactions performed by a user with the online service application 115. A session replay may also be referred to herein as a replay. For example, the user interactions may be displayed as a video displaying the user interactions performed by the user with the online service application 115 during the time interval via a dashboard 125 running on a user device 130. The session replay may be triggered by certain events. The configuration of the online service application 115 may specify the type of events or the conditions that trigger the online service application 115 to save information for allowing the session replay.

The session replay data may be played via a dashboard at a later stage or immediately after the record time interval is finished. The configuration may specify the session replay duration in terms of a predefined number of time units, for example, seconds or minutes. A session replay may be associated with a survey or may be a standalone survey that is not associated with a survey. The replay of the session allows a user, for example, a system administrator to review information associated with an event or a survey. For example, if a user indicates in the survey triggered by an event, that the user is not satisfied with certain feature, the session replay of the time interval during which user performed the survey as well as the interactions performed before and after the survey allow a system administrator to determine what may have caused the user to be dissatisfied. Alternatively, if a new feature is released via the online service application 115, the session replay may allow a system administrator or an analyst to determine whether users are struggling while using the feature.

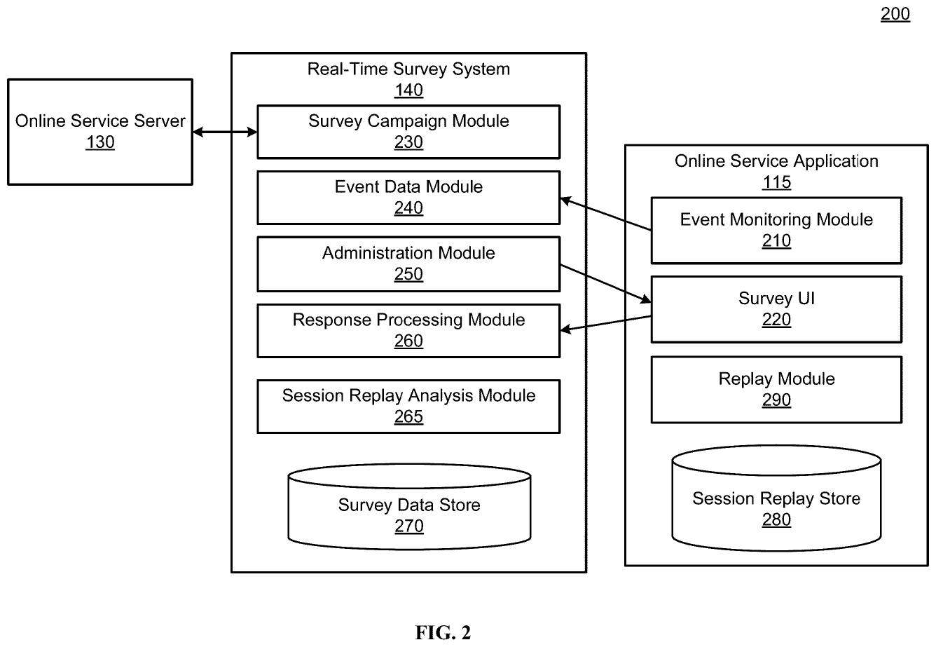

The session replay may allow an analyst to review the user interactions and determine whether a particular aspect of the user interface associated with the feature is confusing the users. For example, if the feature may cause a widget to display via a user interface requesting the users interact with the widget. However, if at that stage of the feature, the user ends up interacting with other portions of the user interface, an analyst may determine that the user interface needs to be redesigned since the user interface is not clearly conveying to the user, the particular user interaction expected from the user at that particular stage of the feature. The session replay feature allows system administrator or analyst to perform such analysis. The online service application will be discussed further in relation to FIG. 2.

In some implementations, the user devices 110, online service server 130, and real-time survey system 140 are configured to communicate with each other via the network 120. The network 120 can comprise any combination of local area and/or wide area networks and both wired and/or wireless communication systems. The network 120 can use standard communications technologies and/or protocols such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, some or all communication links of the network 120 are encrypted or otherwise secured using any suitable technique or techniques.

The online service server 130, according to some embodiments, includes a set of servers or other computing systems capable of controlling and delivering content to users via the online service application 115, managing user interaction with the online service application 115, and/or providing a service to users of the online service application 115. The online service server can include conventional computing systems, such as server computers, server clusters, cloud storage or computing capability, or other suitable systems. The online service server 130 can be configured to communicate with user devices 110 or the real-time survey system 140 via the network 120.

Depending on the implementation, the online service application 115 can provide many different types of service to users. For example, the online service server can provide content (for example user-created, entertainment, artistic, or editorial content), allow for ecommerce, or allow users to play games, among many other potential features that could be provided by the online service server 130. In some cases, the administrators of the online service server 130 seek to improve the user experience of users of the online service application 115 or gain a better understanding of how users are using the online service application 115 through surveying users through the real-time survey system 140. The real-time survey system 140 can be an outside vendor or otherwise separate from the online service server 130 or, as described above, can be integrated within the online service server 130.

In some embodiments, the real-time survey system 140 (also referred to as the RTSS 140) is a set of servers or other computing systems capable of managing and executing one or more survey campaigns gathering data from users of an online service application 115. The RTSS 140 can include conventional computing systems, such as server computers, server clusters, cloud storage or computing capability, or other suitable systems. The RTSS 140 can be configured to communicate with user devices 110, 130 or the online service server 130 via the network 120.

As used herein, a survey is an individual set of questions that can be sent to one or more users as part of a survey campaign. Some implementations and examples are described herein in the context of “microsurveys” or short surveys often containing two or less questions, though these techniques can also be implemented with longer formats of survey. A survey campaign (as administered by the RTSS 140) includes a process of generating and sending surveys to multiple users to and analyzing the received results to determine a result of the survey campaign. In some implementations, the RTSS 140 can dynamically assign surveys to users for many different simultaneous survey campaigns. Because the same user may be eligible for many different surveys assigning users is not trivial and may require selection between multiple campaigns a given user is eligible for. In some embodiments, the RTSS 140 can automatically analyze user responses to survey questions (including difficult to interpret freeform questions). The RTSS 140 can interface with the online service application 115 running on a user device 110 to display survey content to a user of the device 110.

FIG. 1B is a screenshot of a dashboard 125 that allows a user to view session replays captured by the system according to an embodiment. The dashboard is also referred to herein as the dashboard application or the dashboard user interface. The session replay data from various user devices 110 running instances of online service application 115 may be stored in a storage that is accessible to the dashboard 125 running on the user device 130. For example, the session replay data may be stored in a cloud storage. The various session replays may be indexed by identifiers of users that were interacting with the online service application 115 when the session replay was captured. The dashboard 125 shows user identifiers 155, for example, emails 155 of the user associated with the user device 110 running the online service application 115 that caused the session replay to be generated. The system administrator interacting with the dashboard 125 can select an email 155 to see the session replays associated with the email. The dashboard 160 displays the session replay, for example, as a video 150. The dashboard 160 allows the system administrator to interact with the session replay using various widgets 165 that cause the session replay to perform various operations such as pause, play, rewind, forward, change speed of play, skip inactivity in the session replay, and so on. The dashboard 125 also displays metadata 170 describing the session replay. For example, if the session replay is associated with a survey, the metadata 170 may describe the survey such as name, status (whether completed or not). The metadata may describe the event that triggered the session replay or the event that triggered the survey associated with the session replay.

FIG. 2 is a block diagram showing the architecture of a real-time survey system, in accordance with an example embodiment. The RTSS 140 shown in FIG. 2 includes a survey campaign module 230, event data module 240, administration module 250, response processing module 260, a session replay analysis module 265, a survey data store 270, and a session replay store 280. The RTSS 140 is in communication with the online service server 130 and an online service application 115, which includes an event monitoring module 210 and survey UI 220. In other embodiments, the RTSS 140 and online service application 115 can include additional, fewer, or different components for various applications. Conventional components such as network interfaces, security functions, load balancers, failover servers, management and network operations consoles, and the like are not shown so as to not obscure the details of the system architecture.

The online service application 115 shown in FIG. 2 includes an event monitoring module 210 which can gather data about users' actions as they interact with the online service application 115.

Event data gathered by the event monitoring module 210 can include an identifier of the event, an identifier of the user and/or user device 110, a timestamp of the event, and/or other properties of the event. In some embodiments, the event monitoring module 210 sends collected event data to the RTSS 140 for use in selecting surveys for that user. Event data can be collected, processed, and sent by the event monitoring module 210 in real-time or near real-time such that the RTSS 140 can send relevant surveys in a timely manner.

For example, the event monitoring module 210 can collect event data when a user clicks on links within the online service application 115, view or interacts with content through the application 115, uses one or more features of the application 115, or generally interacts with the application 115 in a measurable way. In some implementations, the event monitoring module 210 can collect data on “programmatic events” tracking action that users take within the application 115, such as logins, cart checkouts, or completed transactions. Similarly, the event monitoring module 210 can monitor “URL events” triggered when a user visits a specific page or type of page within the application 115 (for example, a page with a URL matching a predetermined pattern). Additionally, “interaction events” triggered when a user interacts with a specific element of a UI (such as a button, menu, or text field) can be monitored. Not all events or event types may be monitored for each application 115, depending on the type and features of the application 115 and the requirements of survey campaigns being run by the RTSS 140.

The replay module 290 determines and stores information for performing session replays. According to an embodiment, the replay module 290 captures events and stores them in the session replay store 280 on an ongoing basis. The replay module 290 determines whether an event has triggered a session replay. If the session replay is triggered, the replay module 290 retains the event data stored for a past time interval of the length configured for the session replay. If no events trigger a session replay for more than a threshold time, the replay module 290 may delete event data for older events.

The session replay store 280 stores information describing various session replays, for example, event data describing events that occurred in a time interval associated with session replay. According to an embodiment, the information describing a session replay describes the various events that occurred during the time interval of the session replay. The session replay store 280 may associate each session replay with a user identifier of the user of the device that caused the session replay to be triggered. The data related to a session replay may be moved to another system, for example, the RTSS 140 or to a cloud storage for access by a dashboard 125.

The survey UI 220 of the online service application 115 can, in some implementations, receive survey content from the RTSS 140 and display the survey to the user through a user interface allowing the user to respond to survey questions. After collecting the user's responses, the survey UI transmits the gathered responses to the RTSS 140 for aggregation and analysis. Each survey response sent by the survey UI 220 can include an identifier of the survey the user was shown, the content of the user's response(s), which can include freeform text answers, multiple choice selections, and other types of responses, a timestamp of the response, and (in some implementations), an identifier of the user providing the response.

In some embodiments, by embedding the survey content within the online service application 115 itself, use of the RTSS 140 reduces the computational load on the user device 110, which otherwise would have to use a separate email application or generate a new browser window (potentially requiring opening a separate application browser application). Instead, directly including the survey within the survey UI 220 improves the responsiveness of the user device 110 in displaying surveys (for example reducing the time between receiving a survey and actually having survey content displayed to the user) and can improve the user experience for a user receiving a survey.

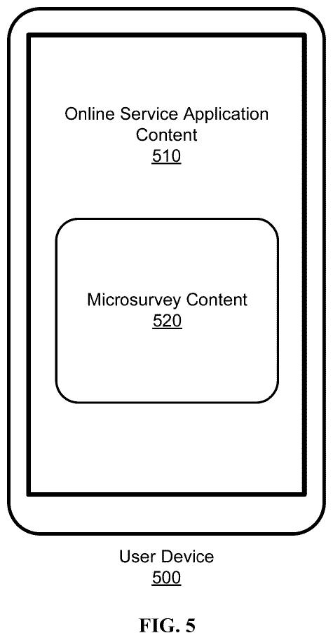

The survey UI can be displayed as a pop-up over an existing UI of the online service application 115, be presented in its own UI screen, or be presented to a user in another suitable fashion. In some implementations, survey content can be received by the survey UI 220, which can wait until a later time to administer the survey. For example, the survey UI 220 may wait until a user is finished entering payment details or the like before disrupting the user with a survey. A simple example survey UI is shown in FIG. 5.

In some implementations, the RTSS 140 selects and administers surveys for one or more survey campaigns based on event data and user attributes about users of an online service application 115. As described above, events represent data about discrete actions or conditions met by a user at a certain point in time. Attributes, as used herein, are pieces of descriptive information about users, such as persistent characteristics or demographics. In some implementations, events may be automatically detected and forwarded to the RTSS 140. Similarly, attributes can be directly provided by users based on information provided by the user at sign-up for the service (or at another explicit opt-in point), received directly from an online service application 115, or provided by the online service server 130 in the form of a user attribute file, public API, or database access. For example, when users may provide email, product plan, and geographic location/address attributes when they create a paid account with the online service application.

In some embodiments, the survey campaign module 230 sets up and maintains survey campaigns for one or more online services 130. The survey campaign module 230 can communicate with the online service server 130 to determine parameters for various survey campaigns. For example, a survey campaign can include one or more surveys, each with different questions and different prerequisites for being shown to users (herein, “survey constraints”). For example, survey constraints can select for users who triggered a certain event within a threshold time or users associated with a given event a threshold amount of times. A survey campaign can also have other properties such as a resurvey rate controlling how often the same user can be surveyed (for that campaign or for any survey sent by the RTSS 140) and a desired response rate or target sample size for collecting data. Once a survey campaign is set up and activated, the RTSS 140 can begin monitoring event data and sending surveys to users for that survey campaign.

A survey campaign can also be associated with one or more parameters of the survey campaign itself, for example if the survey campaign is a fixed or continuous survey campaign. In a fixed campaign, the exact amount of responses they would like to receive (i.e. the sample size of the survey) is defined at campaign creation. The RTSS 140 can then serve surveys until the desired sample size is reached before ending the survey and returning analyzed results. A continuous campaign can instead run for an extended period of time, with a desired number of responses per day defined at campaign creation. For continuous surveys, the RTSS 140 can serve surveys throughout the day until the daily response threshold is reached and then wait until the next day to collect more responses. If the threshold is not achieved for a specified day, the system will attempt to “catch up” in the future by collecting more than the daily response threshold.

For example, if an ecommerce online service 130 would like to gather information from customers in Brazil via a survey sent at the moment of checkout, the survey campaign could be configured to use geographical location attributes (provided by the service 130) for each user and monitored programmatic events tracking when a user completes the checkout process to trigger a survey. Once the campaign is activated, the RTSS 140 would serve surveys to and collect responses from Brazilian users who had just completed checkout.

The event data module 240, according to some embodiments, collects and stores received attribute data and event data collected by the online service applications 115. In some implementations, the event data module 240 stores the received data in the survey data store 270. Surveys can include constraints based on historical event data or previously provided attributes, for example a survey could be sent to users who previously used a feature, but haven't recently, or the like. Once collected and logged by the event data module 240, the event and attribute data is ready to be used by the RTSS 140. In some implementations, the event data module 240 collects and stores data in real-time to facilitate real-time triggering of surveys for users based on currently occurring actions.

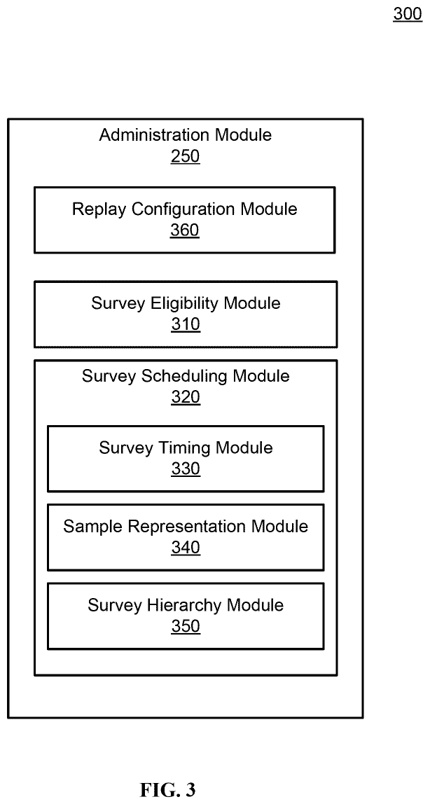

The administration module 250 allows users to configure replays. For example, the user may create and specify details of a standalone replay or a replay associated with a survey. In some implementations the administration module 250 selects and administers surveys to users for survey campaigns based on collected event and attribute data. In some embodiments, administering surveys is a multistep process. In the filtering stage the administration module 250 can determine which users are eligible to receive a survey using both events and attributes. Then the administration module 250 can trigger the actual sending of the survey by determining when a survey is shown to an eligible visitor using event data. The administration module 250 will be discussed further in relation to FIG. 3.

The response processing module 260 receives and analyzes survey responses from administered surveys. In some embodiments, the response processing module 260 uses machine learning techniques and NLP (natural language processing) to automatically analyze survey data. After analysis, the response processing module 260 may send analysis results to the online service server 130 if appropriate. The response processing module 260 may also monitor the overall number of responses for a given survey campaign and determine if enough data has been collected or surveying should continue (based on the properties of that specific campaign).

The session replay analysis module 265 performs analysis of the data gathered via session replays. For example, the session replay analysis module 265 may use machine learning techniques to analyze session replays. After analysis, the session replay analysis module 265 may send analysis results to the online service server 130 if appropriate. The session replay analysis module 265 may perform the analysis of sessions replays on demand based on a request by a user, for example, a system administrator. Alternately, the session replay analysis module 265 may automatically perform analysis of the session replays to determine if any anomalous behavior is observed and sends an alert, for example, a message to a system administrator if an anomalous behavior is identified based on the analysis of the replay.

The survey data store 270 includes one or more databases, cloud storage solutions, or the like used to store survey campaign details, user attributes, collected event data, and user survey responses. The survey data store 270 can be implemented using any suitable technology and may be local to the RTSS 140, remotely connected via the network 120, or the like.

### Survey and Replay Administration

FIG. 3 is a block diagram of an administration module of a real-time survey system, in accordance with an example embodiment. The administration module 250 shown in FIG. 3 includes a replay configuration module 360, a survey eligibility module 310, and a survey scheduling module 320. The survey scheduling module 320 of FIG. 3 includes a survey timing module 330, a sample representation module 340, and a survey hierarchy module 350. In other embodiments, the administration module 250 includes additional, fewer, or different components for various applications.

The replay configuration module 360 configures replays for an online service application 115. The replay may be configured to be associated with a survey, for example, a ne survey or an existing survey. A replay may be created as a standalone survey. For a standalone replay, the relay configuration specifies details of a type of event that triggers the replay. A replay associated with a survey is also associated with the event that triggers the survey. Accordingly, each survey is associated with a trigger event. A replay associated with a survey can be played from a user interface displaying information for the survey. The replay configuration may specify a length of time for which the replay is captured. The length of time for which the replay is captured includes a period of time before the event that triggers the replay. For example, the replay may be configured to capture at least 2 minutes of user interactions with the online service application 115 before an event that triggers the replay occurs. Examples of events that trigger a replay or a survey associated with a replay include a particular type of user interaction, for example, a user clicking on a link, a user clicking on a particular widget (e.g., a submit button), and so on. Other examples of events that trigger a replay or a survey associated with a replay include a particular type of action performed by the online service application 115, for example, sending a message, configuring and causing a particular user interface to be displayed, running particular query, executing a particular set of instructions (e.g., a function or method), and so on.

In some implementations, the survey eligibility module 310 can determine which survey campaigns and/or surveys a user is eligible to receive. As described above, each survey and/or survey campaign can be associated with a series of survey constraints which a user has to meet in order to be eligible to receive that survey. A survey constraint can be a filtering constraint (based on one or more attributes or events associated with the user) or a trigger constraint (based on a recently received event). The survey constraints for each survey can be set up with the survey campaign. In some embodiments, the survey timing module 330 evaluates a user for survey eligibility each time one or more events occur, for example, on session start or when new event or attribute data becomes available for the user.

For example, a filtering constraint can determine user eligibility using attributes based on a user having an attribute of a certain range, or part of a desired set of values, for example if the user is a part of one or more given demographic groups (such as an age group) or if a user's on-file address is within a specified geographic area. Similarly, filtering constraints can use historical event data, determining eligibility based on if the user is (or is not) associated with a specified event within a specified timeframe. Event filtering constraints can count recent event occurrences, time since the event was first recorded for the user, time since the event was last recorded for the user, or if the user has ever triggered the specified event. For example, an event-based filtering constraint can check if a user has logged in (a programmatic event) more than X times within the last week to determine eligibility for a survey aimed at frequent users of the online service application 115.

Similarly, trigger constraints can depend on event data received by the RTSS 140, but instead of relying on stored historical event data, trigger constraints can depend on recent event data (for example, event data from a user's current session using the online service application 115). For example, trigger constraints can select users who have recently performed a specified action within the online service application 115 (based on receiving a programmatic event, such as a logins, cart checkouts, or completed transactions), visits a certain part of the online service application 115 (using URL events, as described above), or interacts with a specific part of a the application UI (through receiving an interaction events for the user). In some implementations, the trigger constraint(s) for a survey can ensure the real-time relevance of the survey to actions the user has just taken (or are currently in the process of taking) as they interact with the online service application. Using trigger constraints as described can lead to higher quality survey responses (as the user still remembers the experience in question) as well as the ability to target surveys to smaller or less prominent interactions the user is unlikely to remember after the fact.

In some implementations, the survey timing module 330 also checks the resurvey rate constraint to prevent users from being spammed by surveys. As described above, the resurvey rate of a survey can be expressed as a minimum number of days between surveys. If a user is within the resurvey window, the survey timing module 330 can determine that the user is ineligible to receive further surveys until outside the resurvey window. In some implementations, the resurvey rate is one survey every 30 days (although the specific resurvey rate can depend on the implementation or be based on the survey campaign).

Each user can be simultaneously eligible for multiple surveys associated with multiple different survey campaigns and the survey timing module 330 can separately evaluate eligibility for each currently active survey campaign. At this point, the administration module 250 can identify that user that is eligible to receive the survey, but not when or if that user should be sent a survey.

In some implementations, the survey scheduling module 320 determines if and when a survey should be shown to an eligible user. The survey scheduling module 320 can mitigate or eliminate result bias that could occur due to uneven sampling of users. According to some embodiments, the survey scheduling module 320 collects survey responses over time, to ensure that all users of the online service application 115 have a more equal chance of being selected (and not unintentionally favoring users in certain time zones or who use the application 115 at certain times of day). Similarly, the survey scheduling module 320 can regulate response collection across one or more user attributes (such as user demographics, customer type, etc.) to ensure a representative sample.

For example, a survey campaign can be set up with a fixed sample size of desired responses (per-day or in total), after which response collection is halted. Exceeding the fixed sample size is undesirable, leading to excess costs and unnecessary disruption of users' experiences with surveys, so the survey scheduling module 320 can aim to send out surveys at a relatively constant rate over a few days to get a representative sample of users in the set of responses.

The survey timing module 330 of FIG. 3 can, in some implementations, determine when eligible users should be sent surveys. In some embodiments, each survey or survey campaign is associated with one or more parameters influencing the timing of the survey. Survey timing parameters can be individual timing parameters (affecting when a specific user is sent a survey within their session of using the online service application 115) or campaign-wide timing parameters (controlling the overall rate of survey collection for that survey/campaign over time).

In some implementations, individual timing parameters include a session timing parameter represented as a number of seconds or range of time after the start of a session when the user can be sent the survey. Additionally, a survey can also be associated with event timing parameters associated with certain events. For example, an event timing parameter can specify a range of time after a certain event (in some cases the event triggering the survey) the survey should be sent.

Campaign-level timing parameters, in some embodiments, regulate the overall response collection rate of the survey campaign. In some implementations, campaign timing parameters are set to achieve a roughly target rate of responses per day. For example, a survey campaign can use a sampling rate setting a fixed percentage of eligible users (such as 5% or 10%) to be sent surveys. In some implementations, the sampling rate is set based on the desired sample size and/or desired responses per day and the estimated number of eligible users each day.

In some embodiments, the survey timing module 330 uses a leaky bucket algorithm to regulate the sampling rate of a survey campaign. A leaky bucket algorithm can regulate both the average survey rate and the maximum number of simultaneous surveys sent out at once for a survey campaign. When using a leaky bucket algorithm, each campaign is associated with a “bucket” (a buffer of a predefined size). The bucket is filled by a predetermined amount whenever a survey for the survey campaign is sent and empties (“leaks”) at a fixed rate over time. If the bucket is too full to fit a new survey, that campaign is treated as inactive and no further surveys are sent until the buffer empties enough (at the fixed rate) for new surveys to be sent out without exceeding the capacity of the bucket. By varying the size of the bucket and the rate at which it empties, the survey scheduling module 320 can control the maximum rate surveys are sent out (by controlling the rate the bucket empties) and the maximum number of surveys that can be sent out at once (by setting the size of the bucket).

In some implementations, the survey timing model 330 uses a cross-leaky bucket algorithm to determine which survey to send out of a set of survey campaigns the user is eligible for. In a cross-leaky bucket algorithm, the survey timing model 330 simultaneously evaluates the leaky bucket buffer for each eligible campaign and selects a single survey based on the amount/percentage of space left in the buffer (and/or other suitable factors).

In some implementations, the survey scheduling module 320 can schedule a survey to be sent at a future time when the timing parameters are met. Then the survey scheduling module 320 can hold the survey and send it to the user's online service application 115 at the scheduled time. For example, the survey timing module 330 can determine to send a survey to a user based on recently received event data but the survey scheduling module 320 waits to actually transmit the survey to the online service application 115 until the scheduled time are met a few seconds or minutes later (when the timing constraints are met).

The sample representation module 340, in some implementations, can ensure that each survey campaign surveys a representative sample of the total population of users. The sample representation module 340 can calculate the current sampling rate across one or more user attributes (or other characteristics) and compare that to target sampling rates representing a balanced sample. For example, the sample representation module 340 can pause or reduce the rate of collection of survey data for over-sampled groups. In other implementations, the sample representation module 340 assigns a weight to each eligible user measuring the extent that user would contribute to over-sampling or help with under-sampling if surveyed. The survey hierarchy module 350 can then use the generated weights to prioritize which survey the eligible user is sent. Implementing sample representation logic as described can reduce the total number of surveys that need to be sent out to receive a representative sample of responses, saving computing resources (and user annoyance) that may be used to run additional surveys.

In many situations, a user will only be eligible for one active survey (which the survey scheduling module 320 can then send to the user), however, a given user may be eligible for multiple surveys simultaneously in some cases. The survey eligibility process can be first performed in parallel for each separate survey campaign, therefore if multiple survey campaigns are running simultaneously for the same online service application 115 a user may be eligible to be sent multiple surveys. If a user is eligible for multiple surveys, the survey hierarchy module 350 can determine which survey should be sent to the user. As described above, the survey timing module 330 can also use a cross-leaky bucket algorithm to select among multiple potential surveys.

In some implementations, the survey hierarchy module 350 ranks the potential surveys based on the current sample breakdown for each survey (for example, assigning a score based on how needed that user is for a representational sample for that survey or using weights generated by the survey hierarchy module 350). Alternatively, the survey hierarchy module 350 can select a survey randomly or semi-randomly or select a survey based on a predetermined hierarchy. In some implementations, the survey hierarchy module 350 selects between surveys using an estimated eligible user rate for each campaign (prioritizing surveys with more restrictive survey constraints that less users meet on average).

In some implementations, after a survey is scheduled to be sent to an eligible user the survey scheduling module 320 stores an event indicating that the survey was sent. Similarly, the leaky bucket for the survey can be updated to reflect the survey being sent and the user's resurvey window can be reset. Then, the survey administration module can send the survey data to the user's online service application 115 for display. For example, the survey data can include an identifier of the survey and survey content containing one or more questions for the user to answer.

### Automatic Replay Analysis

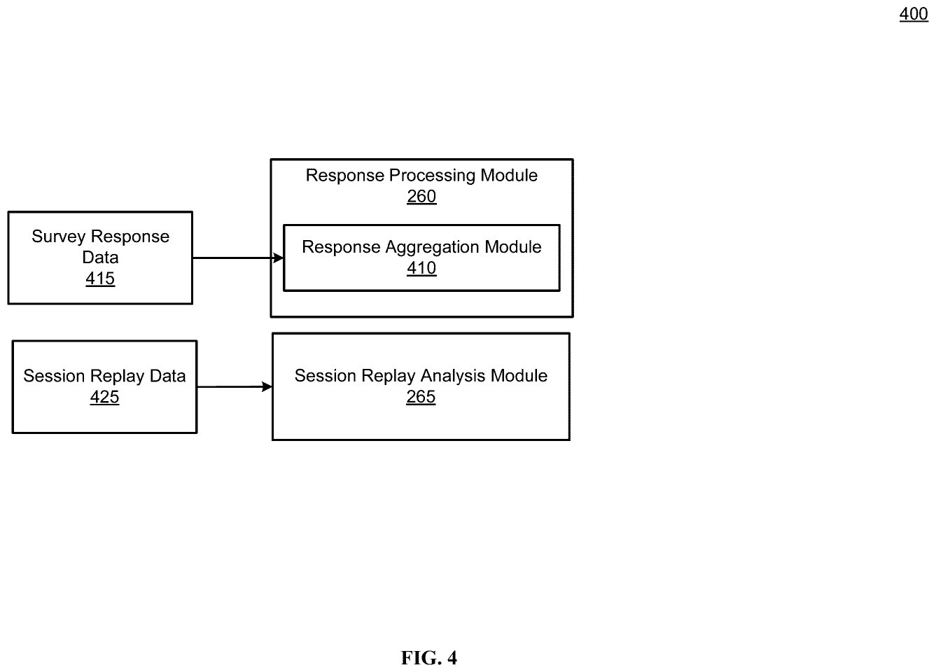

FIG. 4 is a block diagram of a response processing module of a real-time survey system, in accordance with an example embodiment. The response processing module 260 shown in FIG. 4 includes a response aggregation module 410 which collects survey response data 415 and a theme identification model 420 which is a machine learning model trained on topic/intent training data 430 (with topic/intent labels 435) used to analyze the aggregated responses. In other embodiments, the response processing module 260 includes additional, fewer, or different components for various applications.

In some implementations, the response aggregation module 410 receives and organizes survey response data 415 sent by online service applications 115. Each received survey response 415 can include an indication of the survey/survey campaign the results are in response to, a set of one or more question responses provided by the user taking the survey, and, in some embodiments, an identifier of the associated user/user device 110. After receiving a survey response, the response aggregation module 410 can validate and store the survey response in the survey data store 270 for further analysis. In some implementations, the response aggregation module 410 further preprocesses the received data, for example by anonymizing received survey responses 415 by replacing a user identification with generic attribute/event tags (for example for later demographic analysis).

In some embodiments, the session replay analysis module 265 receives and organizes session replay data 425 received from online service applications 115. The session replay data 425 can include event data captured during a time interval associated with the session replay, information describing a survey that may be associated with the session replay, an identifier of the associated user/user device 110, and so on.

According to an embodiment, the response processing module 260 can perform machine learning based analysis of survey responses. Similarly, the session replay analysis module 265 analyzes the session replay data using machine learning models. A machine learning model is an algorithm that is automatically generated based on a set of training data (generally using iterative methods) to predict one or more output values based on a set of input features. A training data set can contain many input features and, in some implementations, the corresponding output values. Depending on the embodiment, the administration module 250 can use many different machine learning techniques, including supervised learning (using training data labeled to include correct output values), unsupervised learning (using unlabeled training data), reinforcement learning, deep learning or neural network algorithms, active learning, and other suitable techniques or algorithms.

According to an embodiment, a machine learning module is trained based on session replay data to determine whether a session replay includes user interactions that deviate from an expected behavior. For example, the machine learning model is trained using several session replay examples that represent expected user interactions (positive training samples) as well as session replay examples that represent unexpected user responses (negative training samples). The machine learning model may be trained to predict a score indicating whether the session replay represents an expected user interaction or an unexpected user interaction. For example, an output score above a threshold value may indicate that the user interaction in the session replay represents an unexpected behavior. The session replay analysis module 265 may send a notification to a user, for example, a system administrator identifying a session replay that needs further analysis.

According to an embodiment, a machine learning module is trained to determine whether a particular event in a sequence of events within a session replay represents anomalous interaction by the user. Accordingly, the machine learning model is executed for multiple events within the session replay to identify a subset of events representing an anomalous user interaction.

### Example Survey UI

FIG. 5 shows an example user interface for displaying real-time survey content to a user of the application, in accordance with an example embodiment. The user device 500 of FIG. 5 includes online service application content 510 overlaid with microsurvey content 520.

The online service application content 510 can include any content or UI elements used for a user to interact with the online service and/or online service server 130. For example, online service application content 510 can encompass ecommerce functionality (such as a checkout or cart UI), content viewing (such as an article reader or video player), video games, or the like.

In some implementations, the survey UI 220 can show survey content (such as microsurvey content 520) by modifying an interface of the online service application 115 to include the received survey content for display. The microsurvey content 520 can include one or more interactive graphical elements that, upon interaction by a user, allow the users to review survey questions and provide answers. For example, a predetermined choice question can be associated with a series of selectable answers while a freeform text question can allow users to enter their answer into a text box. After completion of the microsurvey by the user, the survey UI 220 is configured to modify the interface of the application to remove the survey content 520 such that the user can return to interacting with the online service application content 510.

The microsurvey (or any survey) may be configured to be associated with a session replay. Accordingly, when the microsurvey is triggered by an event, the session replay data corresponding to the microsurvey is made available for display via the dashboard 125.

### Real-Time Survey Processes

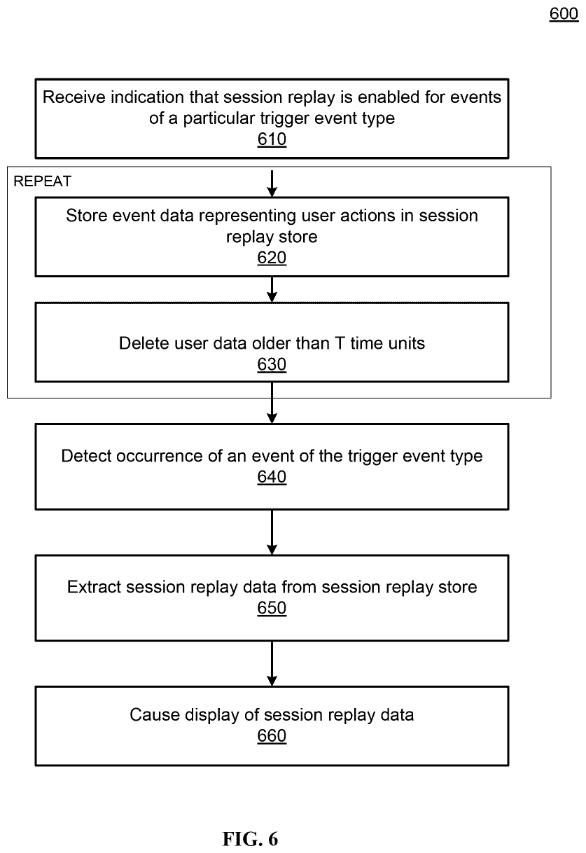

FIG. 6 is a flowchart illustrating an example process for selecting, displaying, and analyzing a real-time survey displayed to a user via a user device, according to an embodiment. The steps of the process may be performed in an order different from that indicated in FIG. 6. For example, certain steps may be performed in parallel. The steps are indicated as being performed by the online service application and may be performed by a module of the online service application, for example, the replay module 290.

The online service application receives 610 an indication that session replay is enabled. The indication may be provided by a user, for example, a system administrator by configuring the application. A session replay may be configured to be triggered by events of a trigger event type. For example, certain types of user interaction may trigger generation of a session replay. This causes the online service application to obtain session replay data relevant to the trigger event. The session replay data captures user interactions associated with the trigger event including user interactions performed before the trigger event and/or user interactions performed after the trigger event.

According to an embodiment, the session replay is configured to be associated with a survey. Accordingly, the session replay data may include one or more of (1) user interactions performed before the event that triggered the survey, for example, user interactions performed within a threshold time of the trigger event and before the trigger event occurred (2) user interactions performed during the survey, and (3) user interactions performed after the survey.

The online service application may display a user interface via a client device. The user interface allows the user of the client device to interact with the online service application. The user interface may also cause the survey to be displayed to the user if the session replay is associated with a survey.

The repeatedly stores 620 in the session replay store 280, event data describing user actions performed via the client device with the online service application. The stored event data retains user actions performed at least for a threshold time interval, for example, a time interval of length T time units. For example, the online service application may delete 630 event data corresponding to user actions that are older that the threshold time, i.e., older than T time units.

The online service application detects an occurrence of a trigger event of the trigger event type. For example, if the trigger event type represents a particular type of user interaction, the online service application detects occurrence of that type of user interaction. Responsive to detecting the occurrence of the trigger event of the trigger event type, the online service application extracts from the session replay store 280, session replay data representing user actions performed with the online service application via the client device within a threshold time interval prior to the trigger event. The session replay data may be displayed via a user interface of a dashboard application.

According to an embodiment, the session replay data is an array of event objects, wherein an event object represents a user interaction. The representation of an event may comprise a serialized representation of a DOM (document object model) representing the user interface of the online service application. The representation of an event may comprise a difference between the DOM representation after the user action compared to the DOM representation before the user action. The various DOM representations allow a system, for example, the dashboard to recreate the user interactions with the online service application.

According to an embodiment, the session replay data is modified before presentation on a dashboard. For example, the online service application may display user information that is sensitive, for example, social security number or any PII (personally identifiable information) of the user. The system modifies the session replay data to mask such information. For example, the system may traverse the DOM representation corresponding to an event in the session replay data, identify the sensitive data, and replace the sensitive data with masked information. For example, fields such as password may be blurred or replaced with generic characters such as stars.

According to an embodiment, the session replay data is compressed for storing in the session replay store or for transmitting the session replay data via a network.

### ADDITIONAL CONSIDERATIONS

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving an indication that session replays are enabled for an online application, wherein a session replay is configured to be associated with events of a trigger event type;
causing, by a client device, a display of a user interface of the online application;
repeatedly performing steps comprising, storing in a replay data store, event data describing user actions performed via the user interface of the online application, wherein the replay data store retains event data representing user actions performed within a recent time interval;
detecting an occurrence of a trigger event of the trigger event type;
responsive to detecting the occurrence of the trigger event of the trigger event type, extracting session replay data representing user actions performed with the online application via the client device within a threshold time prior to the trigger event; and
cause display of the session replay data via a dashboard user interface.

2. The method of claim 1, wherein the trigger event is associated with an online survey associated with the online application, wherein the session replay data comprises user actions associated with the online survey including user actions performed within the threshold time before the trigger event.

3. The method of claim 1, further comprising:
deleting event data representing user actions that are older than the threshold time compared to a current time.

4. The method of claim 1, wherein the session replay data is stored in association with an identifier for a user that performed the user actions via the client device.

5. The method of claim 1, further comprising:
storing session replay data in a cloud storage, wherein the session replay data is accessed from the cloud storage via the dashboard user interface.

6. The method of claim 1, further comprising:
causing for display via the dashboard user interface, information describing a plurality of session replay data, each session replay data associated with a user that caused the user actions recorded in the session replay data.

7. The method of claim 1, further comprising:
modifying at least a portion of session replay data to mask information determined to be sensitive such that the information is blocked while presenting the session replay.

8. A non-transitory computer-readable storage medium comprising instructions which, when executed by one or more processors, cause the one or more processors to perform steps comprising:
receiving an indication that session replays are enabled for an online application, wherein a session replay is configured to be associated with events of a trigger event type;
causing, by a client device, a display of a user interface of the online application;
repeatedly performing steps comprising, storing in a replay data store, event data describing user actions performed via the user interface of the online application, wherein the replay data store retains event data representing user actions performed within a recent time interval;
detecting an occurrence of a trigger event of the trigger event type;
responsive to detecting the occurrence of the trigger event of the trigger event type, extracting session replay data representing user actions performed with the online application via the client device within a threshold time prior to the trigger event; and
cause display of the session replay data via a dashboard user interface.

9. The non-transitory computer-readable storage medium of claim 8, wherein the trigger event is associated with an online survey associated with the online application, wherein the session replay data comprises user actions associated with the online survey including user actions performed within the threshold time before the trigger event.

10. The non-transitory computer-readable storage medium of claim 8, wherein the instructions, when executed, further cause the one or more processors to perform the steps of:
deleting event data representing user actions that are older than the threshold time compared to a current time.

11. The non-transitory computer-readable storage medium of claim 8, wherein the session replay data is stored in association with an identifier for a user that performed the user actions via the client device.

12. The non-transitory computer-readable storage medium of claim 8, wherein the instructions, when executed, further cause the one or more processors to perform the steps of:
storing session replay data in a cloud storage, wherein the session replay data is accessed from the cloud storage via the dashboard user interface.

13. The non-transitory computer-readable storage medium of claim 8, wherein the instructions, when executed, further cause the one or more processors to perform the steps of:
causing for display via the dashboard user interface, information describing a plurality of session replay data, each session replay data associated with a user that caused the user actions recorded in the session replay data.

14. The non-transitory computer-readable storage medium of claim 8, wherein the instructions, when executed, further cause the one or more processors to perform the steps of:
modifying at least a portion of session replay data to mask information determined to be sensitive such that the information is blocked while presenting the session replay.

15. A system comprising one or more processors and a non-transitory computer-readable storage medium storing instructions that when executed by the one or more processors, cause the one or more processors to perform steps comprising:
receiving an indication that session replays are enabled for an online application, wherein a session replay is configured to be associated with events of a trigger event type;
causing, by a client device, a display of a user interface of the online application;
repeatedly performing steps comprising, storing in a replay data store, event data describing user actions performed via the user interface of the online application, wherein the replay data store retains event data representing user actions performed within a recent time interval;
detecting an occurrence of a trigger event of the trigger event type;
responsive to detecting the occurrence of the trigger event of the trigger event type, extracting session replay data representing user actions performed with the online application via the client device within a threshold time prior to the trigger event; and
cause display of the session replay data via a dashboard user interface.

16. The system of claim 15, wherein the trigger event is associated with an online survey associated with the online application, wherein the session replay data comprises user actions associated with the online survey including user actions performed within the threshold time before the trigger event.

17. The system of claim 15, wherein the instructions, when executed, further cause the one or more processors to perform the steps of:
deleting event data representing user actions that are older than the threshold time compared to a current time.

18. The system of claim 15, wherein the session replay data is stored in association with an identifier for a user that performed the user actions via the client device.

19. The system of claim 15, wherein the instructions, when executed, further cause the one or more processors to perform the steps of:
storing session replay data in a cloud storage, wherein the session replay data is accessed from the cloud storage via the dashboard user interface.

20. The system of claim 15, wherein the instructions, when executed, further cause the one or more processors to perform the steps of:
causing for display via the dashboard user interface, information describing a plurality of session replay data, each session replay data associated with a user that caused the user actions recorded in the session replay data.
